(19) United States
(12) Patent Application Publication
(10) Pub. No.: US 2022/0279732 A1
(43) Pub. Date: Sep. 8, 2022

(54) DEVICE FOR IRRIGATING PLANTS

(71) Applicant: Natasha Chappell, Horsham (GB)

(72) Inventor: Natasha Chappell, Horsham (GB)

(21) Appl. No.: 17/764,108

(22) PCT Filed: Sep. 24, 2020
(86) PCT No.: PCT/GB2020/052320

§ 371 Date: Mar. 25, 2022

(30) Foreign Application Priority Data
Sep. 26, 2019 (GB) 1913922.9

(51) Int. Cl. A01G 9/24; A01G 27/00

(52) U.S. Cl. CPC A01G 9/247; A01G 27/005

(57) ABSTRACT

A kit for use in watering a plant includes a drip tray comprising a base having a length being a distance between a first set of two parallel planes and a width being a distance between a second set of two parallel planes defined at sides of the base, each plane of the second set being substantially perpendicular to the planes of the first set, the base having a height being a distance between a first surface and a second surface of the base, wherein a wall upstands from the first surface around its edge at each side of the base and a plurality of channels is defined through the base from the first surface to the second surface, each of the channels configured to have an inlet and an outlet, wherein each inlet has a lip projecting from the first surface.

The present invention relates to a device for irrigating plants and draining away excess water. In addition, the invention relates to a kit for irrigating plants and a method for controlling fluid flow in a top watering system.

### BACKGROUND OF THE INVENTION

It is well established that plants require nutrients to survive. This is especially true for plants grown in containers. In general, the nutrients are absorbed from a rooting medium by roots of the plant. For this reason, one or more fertilisers which include the required nutrients, are commonly fed to plants by growers, typically by placing the fertilisers in or on the rooting medium.

With the proper and timely application of nutrients deemed essential for plant growth and reproduction, a plant may achieve its full potential. However, it is unlikely that all of the nutrients provided to a plant will find their way to the plant's roots. This can be problematic because inorganic and synthetic fertilisers commonly marketed to growers often include nutrients in the form of mineral salt ions and nutrients not taken into the plant can remain in the soil in salt form and they can slowly build up over time.

Poor drainage, under-watering, excessive application rates, imbalanced nutrient ratios and rigorous feeding schedules can lead growers down a potentially dangerous path for a plant because salt build up can eventually cause problems, such as nutrient lockout, which can kill a plant.

Rooting media that have high soluble salt content generally have a high pH level. As the pH of a rooting substrate rises, it results in a change in the overall availability of certain nutrients, and sometimes it can even cause an alteration in the ionic form of some nutrients, changing them into unusable forms. In these cases, the plant might show visual signs of a mineral deficiency—mainly of micronutrients—but this can be misleading. Though the apparent deficiency might be real, adding more fertilizer would exasperate the situation, leading to more plant injury.

Some signs of high salt concentration in the rooting medium include a browning of the leaf tips, reduced growth (especially new growth), the aborting of lower leaves, dead root tips and wilting.

In light of this, growers might find it beneficial, if not imperative, to flush or leach the rooting medium to clear out any unwanted fertilizer salt build up. This involves allowing a relatively large amount of water to flow freely through the rooting medium in a small amount of time to dissolve the fertilizer salt, leaching it away as water travels through and out of the medium. The amount of water required and the frequency depends on the type of rooting medium being used and the frequency/amount of fertilization applied. Mediums such as perlite and expanded clay will require less water to successfully flush out excess salt than a soilless growing medium containing coco coir or a rockwool slab would.

Drainage is critical following flushing. In this regard, after flushing, it is important to allow as much of the water to drain from the rooting medium as possible. If left in the water used for flushing, the medium will end up re-absorbing the salt intended for removal, and the water can become stagnant and harbour bacteria.

Known systems for watering and flushing the rooting medium drip water onto the rooting medium. However, they only allow the water to drip onto one or two small areas of the surface of the rooting medium thereby leaving untouched areas and this leads to nutrient salt build ups on and below the remaining surface. In addition, drainage of water in the known systems is often unreliable or fails and this can be damaging to plants. In this regard, the debris, for example dirt or plant parts such as leaves or broken off roots, can block or interfere with drainage through drainage channels having small diameters.

The present invention seeks to provide an alternative device which preferably addresses one or more of the problems presented by prior art arrangements.

### SUMMARY OF THE INVENTION

The invention is directed to an automated watering system for use with any rooting medium, including one or more of soil, coco coir, rockwool (mineral wool), expanded clay, peat, perlite, vermiculite. The system can be used as a recirculating or run to waste (RTW) system.

In accordance with a first aspect, the invention provides a kit for use in watering a plant, the kit including a drip tray comprising a base having a length being a distance between a first set of two parallel planes and a width being a distance between a second set of two parallel planes defined at sides of the base, each plane of the second set being substantially perpendicular to the planes of the first set, the base having a height being a distance between a first surface and a second surface of the base, wherein a wall upstands from the first surface around its edge at each side of the base and a plurality of channels is defined through the base from the first surface to the second surface, each of the channels configured to have an inlet and an outlet, wherein each inlet has a lip projecting from the first surface.

Preferably, the wall extends substantially perpendicularly from the first surface of the base. Preferably the wall has a height extending from the first surface of the base greater than the height of the lip of each inlet from the first surface of the base.

Preferably, a substantially U-shaped recess is defined in one of the sides of the base for receiving a stem of a plant and the wall extends around the edge of the recess. Preferably, the recess extends approximately half of the distance from a first side of the base to the opposite side of the base. This allows the drip tray to be positioned around the stem of a plant.

In use, the drip tray is positioned substantially horizontally over the surface of a rooting medium and water or nutrient solution is directed to the first surface of the base. The water or nutrient solution flows between the inlets of each channel. As the level of the water or nutrient solution rises above the first surface it reaches the level of the lips of the inlets and falls over the lips into the channels. Water or nutrient solution flows through the channels and drips from the outlets onto the rooting medium.

In one embodiment, the first surface of the base is substantially parallel with the second surface of the base, the base being substantially planar, and, preferably, the lips of the inlets all project substantially equidistant from the first surface of the base. This provides the advantage that, in use, water or nutrient solution spills over each lip at the same time. This provides the advantage of ensuring that all of the medium receives the same amount of water/nutrients and also flushes out old nutrients which are present in the rooting medium but have been depleted of whatever elements have been used by the plant. Therefore the nutrient salts left are either unwanted or unused. To maintain a correct balance of all elements the nutrients should ideally be flushed out and replaced with new/fresh.

In an alternative embodiment, at least one drain channel is defined in the base between the first surface and the second surface of the base, each drain channel being configured to have a drain inlet and a drain outlet, wherein each drain inlet has a lip which is flush with the first surface of the base. In other words, the drain inlet does not project from the first surface of the base. According to this embodiment, the first surface of the base is configured to slope to each drain inlet.

Preferably, the lips of each inlet are level with each other but the first surface of the base is sloped towards the drain holes. In other words, the lips of the inlets closest to the drain channels are further from the first surface than lips of the inlets furthest from the drain channels. In use, when water or nutrient solution is not directed to the first surface of the base, the remaining water or nutrient solution left in the drip tray will be drained. Leaving the water in the drip tray would create unwanted humidity and it could encourage growth of bacteria.

Preferably, the channels are located in frustoconical projections which project from the second surface of the base. Preferably, the outlets of each channel are located at the centre of the apex of each frustoconical projection. Preferably, the base of each frustoconical projection is set into a recess in the second surface of the base. This provides the advantage that water or nutrient solution is accurately dripped from each channel onto the rooting medium.

Preferably, an overflow slot is located in the wall of the drip tray so that, in use, if for any reason all channels become blocked, water or nutrient solution is channelled through the overflow slot directly to the rooting medium rather than spilling over onto the stem of the plant, which could cause stem rot.

Advantageously, the invention provides is a drip feed type (top watering) system that delivers/distributes nutrient solution evenly over substantially the entire surface of the medium with a rain like effect showering down on the medium using the device. Advantageously, this process flushes out old/depleted nutrient salts and replaces with fresh.

In addition, even distribution of water or nutrient solution over the surface of the rooting medium encourages root zones to use all of the medium to thrive.

Furthermore, the drip tray of the invention shades the top of the medium from light. Therefore, light penetration is masked, allowing the medium to dry evenly and efficiently, thereby inhibiting the formation of algae.

Preferably, water or nutrient solution is directed to the first surface of the base. In use, preferably water or nutrient solution is pumped from a reservoir, for example a water tank or water butt, by means of a pump. Preferably, the pump preferably receives a signal from a control unit that is set to power on at a certain time of day.

Preferably, the kit includes at least one pipe and in use, water or nutrient solution is pumped through the pipe. Preferably, a filter is provided, which abuts the pipe and in use it filters any unwanted debris from the water or nutrient solution. Preferably, the water or nutrient solution is directed through the pipe where it is teed off to a plurality of drip trays according to the invention. Preferably, reducing tees are provided to reduce the inner diameter of the pipe down to 4 mm inner diameter pipe. Preferably, one or more clips are provided to hold the pipe in place on one side of the drip tray. Preferably, two clips are provided per drip tray and the pipe is preferably clipped in position by the clips and angled downwards towards the first surface of the base of the drip tray to avoid splashing.

Preferably, the kit includes a fabric felt pot and a rigid pot. Preferably, rooting medium is held in the fabric felt pot which is placed inside the rigid pot. Preferably, the rigid pot has a base and a wall extending upwardly therefrom and a drain channel is located in the base, preferably at or near the centre of the base. Preferably, the rigid pot is manufactured of a plastics material. Preferably, a platform of raised square blocks is provided adjacent the base of the rigid pot to prevent the fabric pot from sitting directly on the base of the plastic pot and blocking the drain channel.

Preferably, the platform is provided above the base of the pot and the drain is sunken below the platform. Preferably, the surface of the platform is angled towards the drain channel so that, in use, no water is left sitting in the base of the pot.

Preferably, the kit includes a drain fitting which preferably mates with the drain in the rigid pot. Preferably, the drain fitting comprises a wall upstanding from an annular base, the wall having an inner surface defining a channel and an outer surface which is threaded, one or more conduits being defined though the wall between its inner surface and its outer surface adjacent the base.

Preferably, the outer surface of the wall is threaded distal to the base and one or more conduits are defined in the wall adjacent the base.

Preferably, at least two conduits are defined in the wall between its inner surface and its outer surface adjacent the base. Preferably, the conduits have slotted openings in the inner and outer surfaces of the wall. Preferably, the longitudinal axis of each slotted opening is parallel with the base.

Preferably, the threaded outer surface of the wall has 1.5″ bsp threads.

Preferably, the fitting is manufactured of plastics material.

Advantageously, in use, the conduits through the wall of the drain fitting allow drainage of any remaining water or nutrient solution which does not go through the channel defined by the wall.

Preferably, a washer is provided, which, in use, abuts the annular base of the drain fitting and the outer surface of the base of the rigid pot. Advantageously, this seals the outer surface of the base of the pot to the annular base of the drain fitting.

Preferably, the washer is manufactured of rubber.

Preferably, a collar is provided which is capable of sliding over the wall of the drain fitting, the collar comprising a wall having a top, a bottom, an inner surface and an outer surface, wherein one or more conduits are defined through the bottom of the wall from the outer surface to the inner surface.

Preferably, one or more projections extend from the inner wall of the collar. Preferably, two projections are provided on the inner wall opposite to each other. Preferably, in use, the projections locate in slots in the outer surface of the wall of the fitting and this prevents the collar rotating relative to the drain fitting. In an alternative embodiment, one or more slots are provided in the inner wall of the collar and one or more projections are provided in the outer wall of the fitting.

Preferably the collar is manufactured of plastics material.

In use, the conduits of the collar align with the conduits of the fitting and they allow water or nutrient solution to pass through.

Preferably, a nut is provided, the nut having threads which are complementary with the threaded surface of the fitting. Preferably the nut is manufactured of plastics material.

In use, the washer is placed on the fitting, the fitting is placed through the drain of the rigid pot, the collar is placed on the fitting and the nut is screwed on to the fitting. The rigid pot is sandwiched between the washer and the collar. This prevents the drain hole of the pot leaking water onto the floor.

Preferably, the drain fitting abuts at least one of a tee, elbow or straight pipe.

### BRIEF DESCRIPTION OF THE DRAWINGS

The invention will now be further described with reference to the accompanying drawings in which:

FIG. 1 shows a view of an embodiment of a drip dray of the present invention;

FIG. 2 shows a further view of an embodiment of a drip dray of the present invention;

FIG. 3 shows a further view of an embodiment of a drip dray of the present invention;

FIG. 4 shows a further view of an embodiment of a drip dray of the present invention;

FIG. 5 shows a further view of an embodiment of a drip dray of the present invention;

FIG. 6 shows a further view of an embodiment of a drip dray of the present invention;

FIG. 7 shows a further view of an embodiment of a drip dray of the present invention;

FIG. 8 shows a further view of an embodiment of a drip dray of the present invention;

FIG. 9 shows a further view of an embodiment of a drip dray of the present invention;

FIG. 10 shows a further view of an embodiment of a drip dray of the present invention;

FIG. 11 shows a view of the base of a pot according to an embodiment of the present invention;

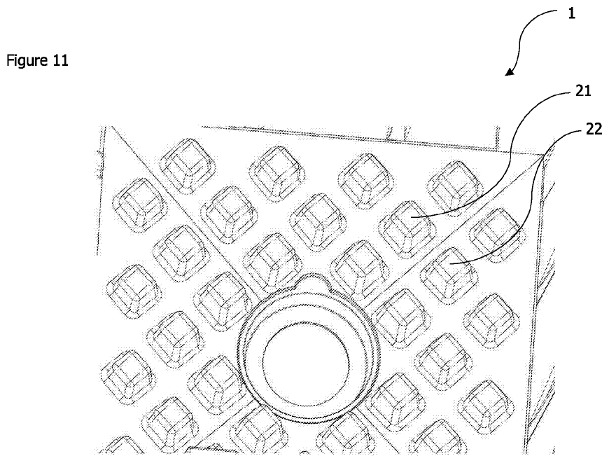

FIG. 12 shows a further view of an embodiment of a drain fitting of the present invention;

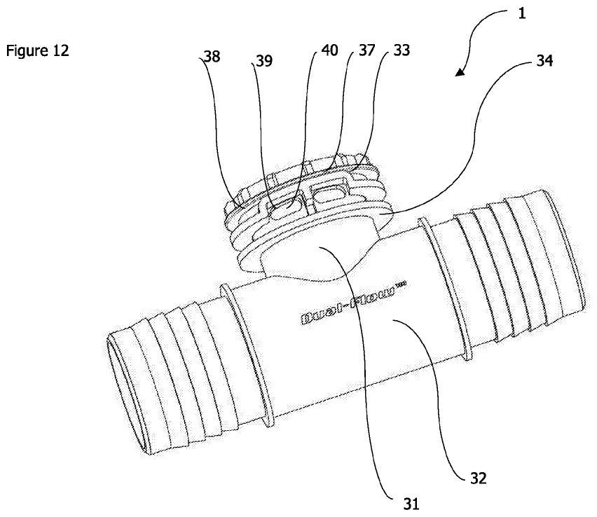

FIG. 13 shows a further view of an embodiment of a drain fitting of the present invention.

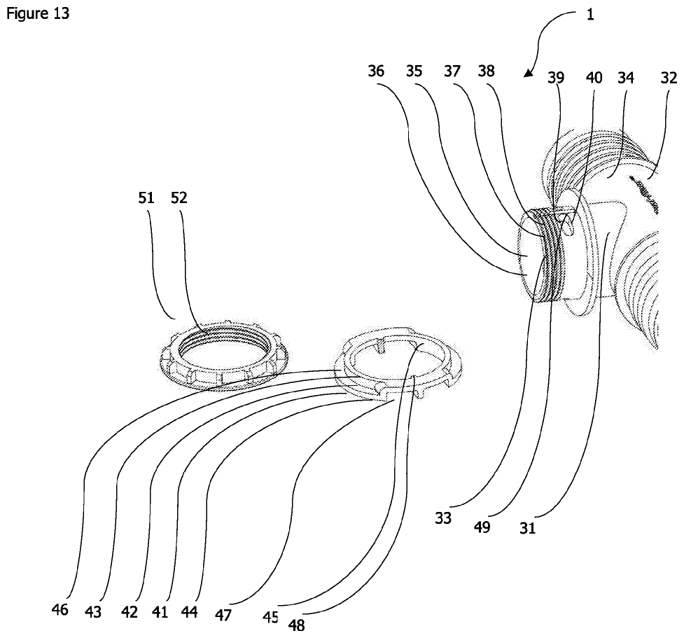

### DETAILED DESCRIPTION OF THE INVENTION

It will be appreciated that aspects, embodiments and preferred features of the invention have been described herein in a way that allows the specification to be written in a clear and concise way. However, unless circumstances clearly dictate otherwise, aspects, embodiments and preferred features can be variously combined or separated in accordance with the invention. Thus, preferably, the invention provides a device having features of a combination of two or more, three or more, or four or more of the aspects described herein. In a preferred embodiment, a device in accordance with the invention comprises all aspects of the invention.

Within the context of this specification, the word “about” means plus or minus 20%, more preferably plus or minus 10%, even more preferably plus or minus 5%, most preferably plus or minus 2%.

Within the context of this specification, the word “comprises” means “includes, among other things” and should not be construed to mean “consists of only”.

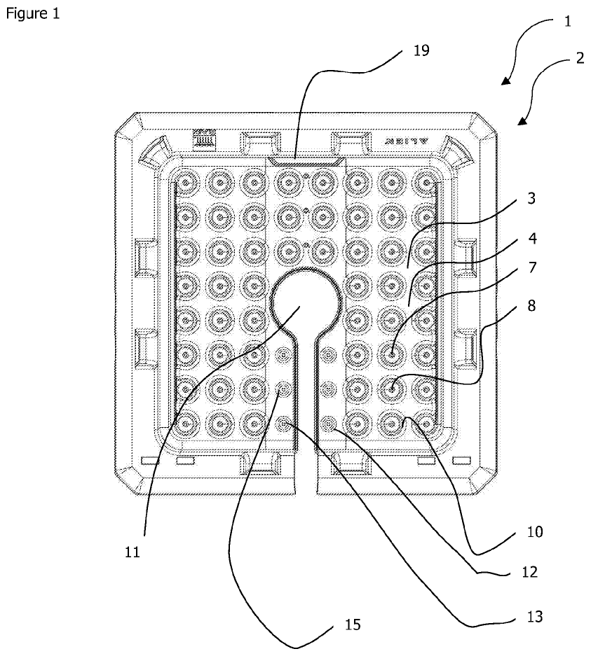

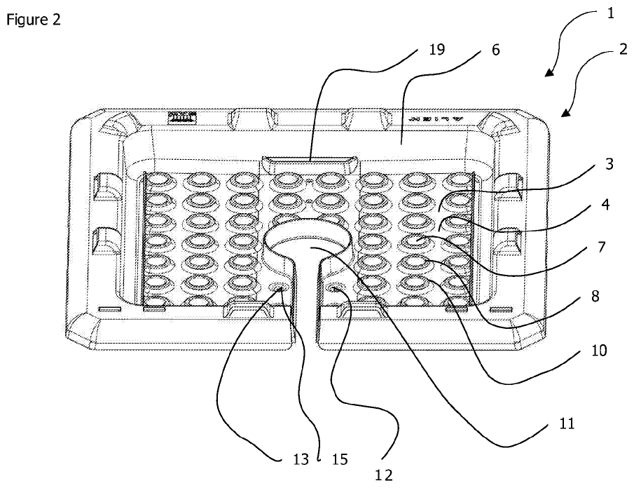

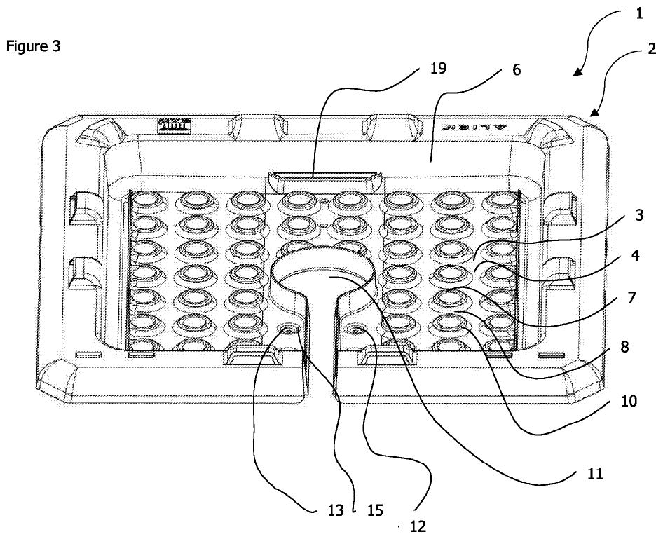

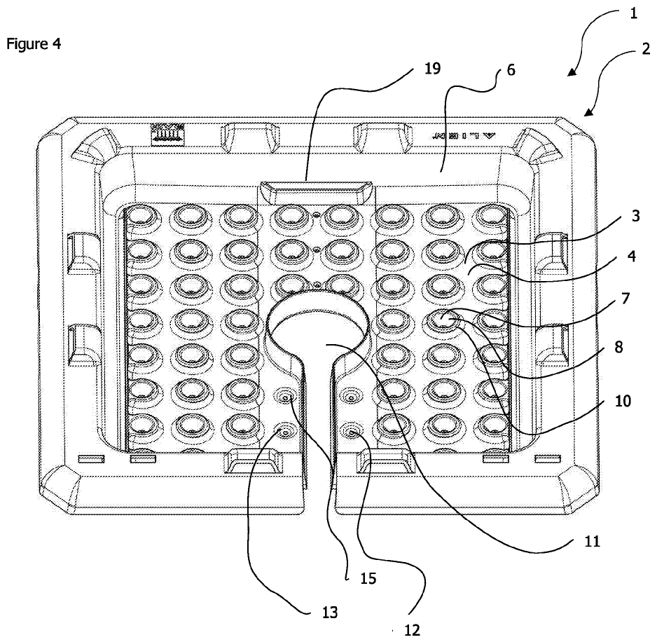

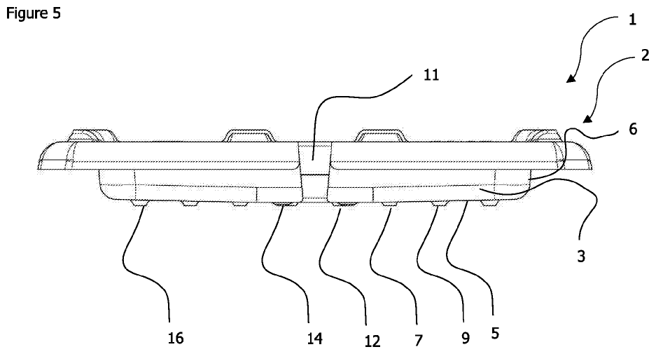

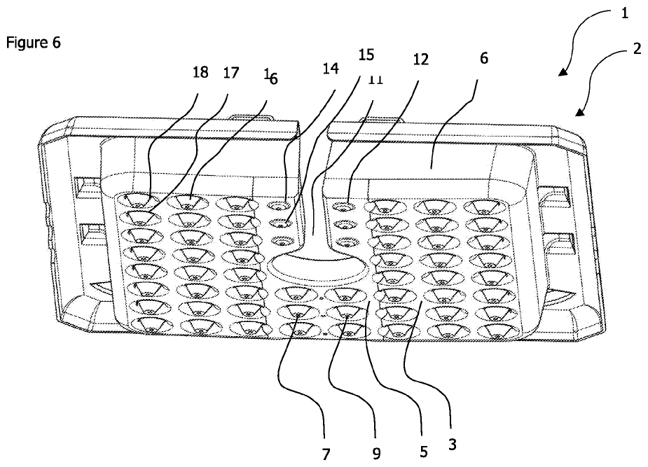

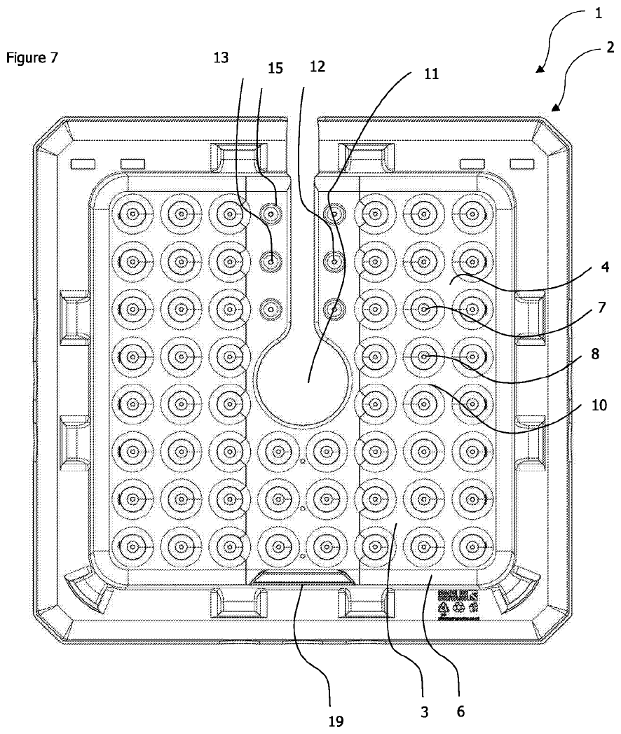

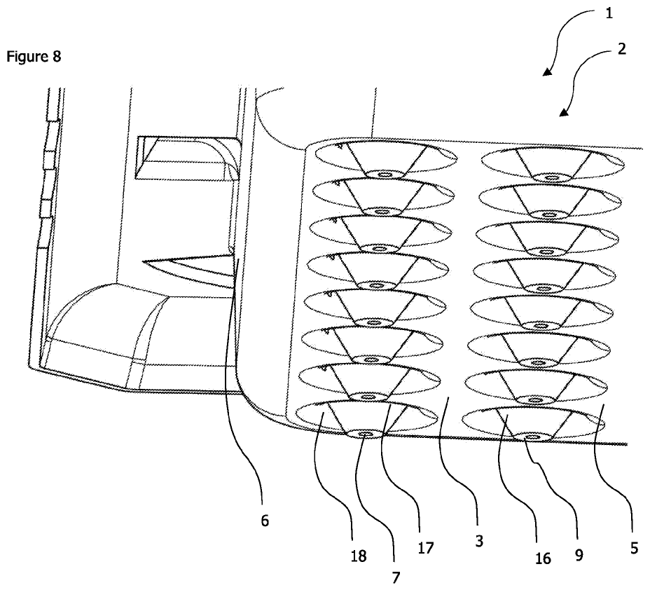

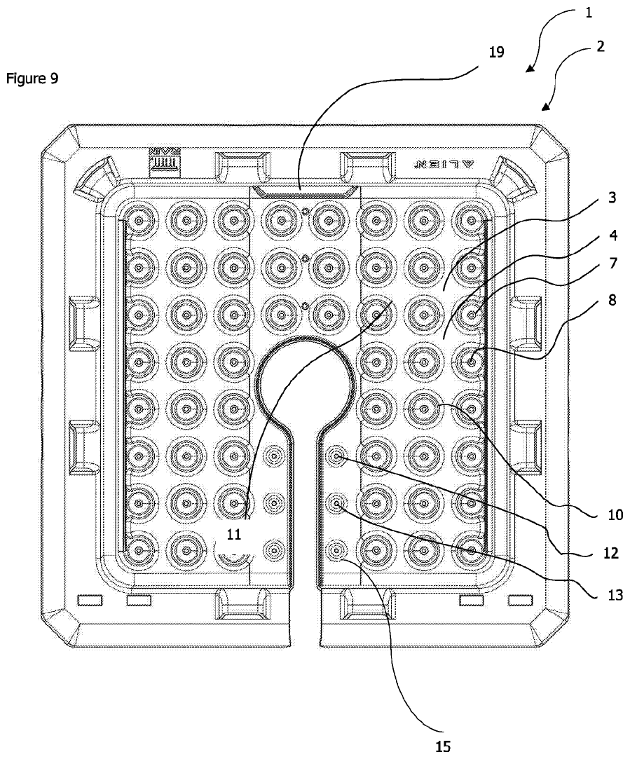

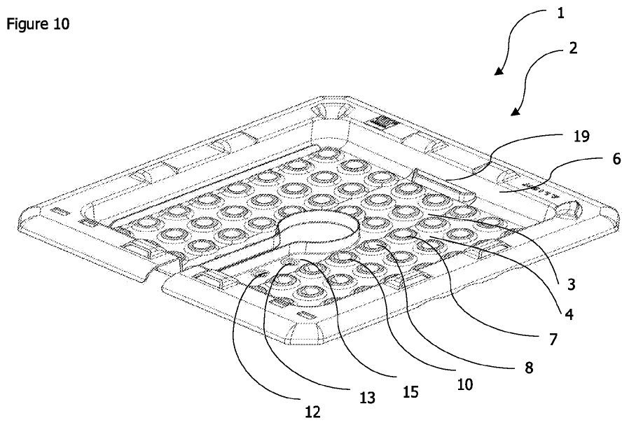

Within the context of this specification, the word “substantially” means preferably at least 90%, more preferably 95%, even more preferably 98%, most preferably 99%. A drip tray in accordance with the invention is shown in FIGS. 1 to 10.

The invention provides an automated watering system (1) for use with any rooting medium, including one or more of soil, coco coir, rockwool (mineral wool), expanded clay, peat, perlite, vermiculite. The system (1) can be used as a recirculating or run to waste (RTW) system.

Advantageously, the invention provides is a drip feed type (top watering) system (1) that delivers/distributes nutrient solution evenly over substantially the entire surface of the medium with a rain like effect showering down on the medium using the drip tray (2). Advantageously, this process flushes out old/depleted nutrient salts and replaces with fresh.

Advantageously, the device (2) of the invention shades the top of the medium from light. Therefore, light penetration is masked, thereby inhibiting the formation of algae. In addition, even distribution of water or nutrient solution over the surface of the rooting medium encourages root zones to use all of the medium to thrive.

In use, water or nutrient solution is pumped from a water tank, for example a water butt by means of a water pump which receives a signal from a control unit that is set to power on at a certain time of day.

The invention is directed to an automated watering system (1) for use with any rooting medium, including one or more of soil, coco coir, rockwool (mineral wool), expanded clay, peat, perlite, vermiculite. The system (1) can be used as a recirculating or run to waste (RTW) system.

As shown in FIGS. 1 to 10, the kit (1) includes a drip tray (2) comprising a base (3) having a length being a distance between a first set of two parallel planes and a width being a distance between a second set of two parallel planes defined at sides of the base (3), each plane of the second set being substantially perpendicular to the planes of the first set, the base (3) having a height being a distance between a first surface (4) and a second surface (5) of the base, wherein a wall (6) upstands from the first surface (4) around its edge at each side of the base (3) and a plurality of channels (7) is defined through the base (3) from the first surface (4) to the second surface (5), each of the channels (7) configured to have an inlet (8) and an outlet (9), wherein each inlet (8) has a lip (10) projecting from the first surface (4).

The wall (6) extends substantially perpendicularly from the first surface (4) of the base (3) and has a height extending from the first surface (4) of the base (3) greater than the height of the lip (10) of each inlet (8) from the first surface (4) of the base (3).

A substantially U-shaped recess (11) is defined in one of the sides of the base (3) for receiving a stem of a plant and the wall (6) extends around the edge of the recess (11). The recess (11) extends approximately half of the distance from a first side of the base (3) to the opposite side of the base (3). This allows the drip tray (2) to be positioned around the stem of a plant.

In use, the drip tray (2) is positioned substantially horizontally over the surface of a rooting medium and water or nutrient solution is directed to the first surface (4) of the base (3). The water or nutrient solution flows between the inlets (8) of each channel (7). As the level of the water or nutrient solution rises above the first surface (4) it reaches the level of the lips (10) of the inlets (8) and falls over the lips (10) into the channels (7). Water or nutrient solution flows through the channels (7) and drips from the outlets (9) onto the rooting medium.

At least one drain channel (12) is defined in the base (2) between the first surface (4) and the second surface (5) of the base (3), each drain channel (12) being configured to have a drain inlet (13) and a drain outlet (14), wherein each drain inlet (13) has a lip (15) which is flush with the first surface (4) of the base (3). In other words, the drain inlet (13) does not project from the first surface (4) of the base (3). The first surface (4) of the base (3) is configured to slope to each drain inlet (13).

The lips (10) of each inlet (8) are level with each other but the first surface (4) of the base (3) is sloped towards the drain channels (12). In other words, the lips (10) of the inlets (8) closest to the drain channels (12) are further from the first surface (4) than lips (10) of the inlets (8) furthest from the drain channels (12). In use, when water or nutrient solution is not directed to the first surface (4) of the base (3), the remaining water or nutrient solution left in the drip tray (2) will be drained. Leaving the water in the drip tray (2) would create unwanted humidity and it could encourage growth of bacteria.

The channels (7) (12) are located in frustoconical projections (16) which project from the second surface (5) of the base (3). Preferably, the outlets (9) (14) of each channel (7) (12) are located at the centre of the apex of each frustoconical projection (16). Preferably, the base (17) of each frustoconical projection (16) is set into a recess (18) in the second surface (5) of the base (3). This provides the advantage that water or nutrient solution is accurately dripped from each channel (7) (12) onto the rooting medium.

An overflow slot (19) is located in the wall (6) of the drip tray (2) so that, in use, if for any reason all channels (7) become blocked, water or nutrient solution is channelled through the overflow slot (19) directly to the rooting medium rather than spilling over onto the stem of the plant, which could cause stem rot.

Water or nutrient solution is directed to the first surface (4) of the base (3). In use, water or nutrient solution is pumped from a reservoir, for example a water tank or water butt, by means of a pump. The pump receives a signal from a control unit that is set to power on at a certain time of day.

The kit (1) includes at least one pipe and in use, water or nutrient solution is pumped through the pipe. A filter is provided, which abuts the pipe and in use it filters any unwanted debris from the water or nutrient solution. The water or nutrient solution is directed through the pipe where it is teed off to a plurality of drip trays according to the invention. Reducing tees are provided to reduce the inner diameter of the pipe down to 4 mm inner diameter pipe. Two clips are provided to hold the pipe in place on one side of the drip tray. The pipe is clipped in position by the clips and angled downwards towards the first surface (4) of the base (3) of the drip tray (2) to avoid splashing.

The kit (1) includes a fabric felt pot and a rigid pot. Rooting medium is held in the fabric felt pot which is placed inside the rigid pot. The rigid pot has a base and a wall extending upwardly therefrom. A drain channel is located in the base at the centre of the base. The rigid pot is manufactured of a plastics material. A platform (21) of raised square blocks (22) is provided adjacent the base of the rigid pot to prevent the fabric pot from sitting directly on the base of the plastic pot and blocking the drain channel.

The platform (21) is provided above the base of the pot and the drain is sunken below the platform. The surface of the platform (21) is angled towards the drain channel so that, in use, no water is left sitting in the base of the pot.

The kit (1) includes a drain fitting (31) of plastics material which mates with the drain in the rigid pot and abuts a tee pipe (32). The drain fitting (31) comprises a wall (33) upstanding from an annular base (34), the wall (33) having an inner surface (35) defining a channel (36) and an outer surface (37) which is threaded with 1.5″ bsp threads (38), two conduits (39) being defined though the wall (33) between its inner surface (35) and its outer surface (37) adjacent the base (34). The outer surface (37) of the wall (33) is threaded distal to the base (34) and one or more conduits (39) are defined in the wall (33) adjacent the base (34). The conduits (39) have slotted openings (40) in the inner (35) and outer (37) surfaces of the wall (33) and the longitudinal axis of each slotted opening (40) is parallel with the base (33).

Advantageously, in use, the conduits (39) through the wall (33) of the drain fitting (31) allow drainage of any remaining water or nutrient solution which does not go through the channel (36) defined by the inner surface (35) of the wall (33).

A rubber washer is provided, which, in use, abuts the annular base (34) of the drain fitting (31) and the outer surface of the base of the rigid pot. Advantageously, this seals the outer surface of the base of the pot to the annular base (34) of the drain fitting (31).

A collar (41) of plastics material is provided which is capable of sliding over the wall (33) of the drain fitting (31). The collar (41) comprises a wall (42) having a top (43), a bottom (44), an inner surface (45) and an outer surface (46), wherein one or more conduits (47) are defined through the bottom (44) of the wall (42) from the outer surface (46) to the inner surface (45). Two projections (48) extend from the inner surface (45) of the wall (42) of the collar (41) opposite to each other. The projections (48) locate in slots (49) in the outer surface (46) of the wall (42) of the fitting (31) and this prevents the collar (41) rotating relative to the drain fitting (31).

In use, the conduits (47) of the collar (41) align with the conduits (39) of the fitting (31) and they allow water or nutrient solution to pass through.

A nut (51) of plastics material is provided, the nut (51) having threads (52) which are complementary with the threads (38) of the fitting (31).

In use, the washer is placed on the fitting (31), the fitting (31) is placed through the drain of the rigid pot, the collar (41) is placed on the fitting (31) and the nut (51) is screwed on to the fitting (31). The rigid pot is sandwiched between the washer and the collar (41). This prevents the drain hole of the pot leaking water onto the floor.

In use, the fitting (31) is sunken into the bottom of the rigid pot. There is an amount of water which cannot usually be drained through the main aperture of the fitting sitting in a sunken drain hole. However, because of the conduits (39) in the side of the fitting (31) and the conduits (47) in the collar (41) of the invention, the remaining water can be drained.

Remarkably, this allows production of a device with technical advantages as will be detailed below.

The invention provides the advantages of
Complete drainage of nutrient solutions
Even delivery of nutrient solution
Allows medium to dry evenly
No surface salt build ups
Old nutrients are flushed out
Slows top soil evaporation
Built-in filtration system
High pressure delivery/distribution pump
Swedish automatic return pump
Allows customisation of feeding schedule
Supports any growing medium
50 mm dual-flow fittings
Flexible pipe
15 litre or 30 litre pots
Fabric Camo-pots
Solid copper or copper plated drain covers
Can be used as run to waste system
Conserves water and nutrients-effectively efficiently
Eliminates top surface algae
root zones dry at a more consistent rate

It will of course be understood that many variations may be made to the above-described embodiment without departing from the scope of the present invention.

1. A kit for use in watering a plant, the kit including a drip tray comprising a base having a length being a distance between a first set of two parallel planes and a width being a distance between a second set of two parallel planes defined at sides of the base, each plane of the second set being substantially perpendicular to the planes of the first set, the base having a height being a distance between a first surface and a second surface of the base, wherein a wall upstands from the first surface around an edge at each side of the base and a plurality of channels is defined through the base from the first surface to the second surface, each of the plurality of channels being configured to have an inlet and an outlet, wherein each inlet has a lip projecting from the first surface.

2. A kit according to claim 1, wherein the wall extends substantially perpendicularly from the first surface of the base.

3. A kit according to claim 1, wherein the wall has a height extending from the first surface of the base greater than a height of the lip of each inlet from the first surface of the base.

4. A kit according to claim 1, wherein a substantially U-shaped recess is defined in one of the sides of the base for receiving a stem of a plant and the wall extends around an edge of the recess.

5. A kit according to claim 4, wherein the recess extends approximately half of a distance from a first side of the base to an opposite side of the base.

6. A kit according to claim 1, wherein the first surface of the base is substantially parallel with the second surface of the base, the base being substantially planar, and the lips of the inlets project substantially equidistant from the first surface of the base.

7. A kit according to claim 1, wherein at least one drain channel is defined in the base between the first surface and the second surface of the base, each drain channel being configured to have a drain inlet and a drain outlet, wherein each drain inlet has a lip which is flush with the first surface of the base.

8. A kit according to claim 7, wherein the first surface of the base is configured to slope to each drain inlet.

9. A kit according to claim 1, wherein the lips of each inlet are level with each other but the first surface of the base is sloped towards drain holes formed therein.

10. A kit according to claim 1, wherein the channels are located in frustoconical projections which project from the second surface of the base.

11. A kit according to claim 10, wherein each frustoconical projection has a base set into a recess in the second surface of the base of the drip tray.

12. A kit according to claim 1, wherein an overflow slot is located in the wall of the drip tray.

13. A kit according to claim 1, comprising a pipe for directing water or nutrient solution to the first surface of the base of the drip tray.

14. A kit according to claim 13, comprising a reservoir.

15. A kit according to claim 14, comprising a pump for pumping water or nutrient solution from the reservoir to the first surface of the base of the drip tray via the pipe.

16. A kit according to claim 15, wherein the pump receives a signal from a control unit that is set to power on at a certain time of day.

17. A kit according to claim 13, wherein a filter abuts the pipe for filtering any unwanted debris from the water or nutrient solution.

18. A kit according to claim 13, wherein the pipe is teed off to a plurality of drip trays.

19. A kit according to claim 13, wherein one or more clips are provided to hold the pipe in place on one side of the drip tray.

20. A kit according to claim 19, wherein two clips are provided per drip tray and the pipe is preferably clipped in position by the clips and angled downwards towards the first surface of the base of the drip tray.

21. A kit according to claim 1, comprising a fabric felt pot and a rigid pot.

22. A kit according to claim 21, wherein a rooting medium is held in the fabric felt pot which is placed inside the rigid pot.

23. A kit according to claim 22, wherein the rigid pot has a base and a wall extending upwardly therefrom and a drain channel is located in the base.

24. A kit according to claim 23, wherein a platform of raised blocks is provided adjacent the base of the rigid pot to prevent the fabric felt pot from sitting directly on the base of the rigid pot and blocking the drain channel.

25. A kit according to claim 24, wherein a surface of the platform is angled towards the drain channel so that, in use, no liquid remains in the base of the pot.

26. A kit for use in watering a plant, the kit including a drain fitting configured for mating with a drain of a rigid pot, the drain fitting comprising a wall upstanding from an annular base, the wall having an inner surface defining a channel and an outer surface which is threaded, one or more conduits being defined though the wall between the inner surface and the outer surface adjacent the base.

27. A kit according to claim 26, wherein the outer surface of the wall is threaded distal to the base and the one or more conduits are defined in the wall adjacent the base.

28. A kit according to claim 26, wherein at least two conduits are defined in the wall between the inner surface and the outer surface adjacent the base.

29. A kit according to claim 26, wherein the one or more conduits have slotted openings in the inner and outer surfaces of the wall and a longitudinal axis of each slotted opening is parallel with the base.

30. A kit according to claim 26, wherein a washer is provided, which, in use, abuts the annular base of the drain fitting and an outer surface of a base of the rigid pot.

31. A kit according to claim 26, wherein a collar is provided which is capable of sliding over the wall of the drain fitting, the collar comprising a wall having a top, a bottom, an inner surface and an outer surface, wherein the one or more conduits are defined through the bottom of the wall from the outer surface to the inner surface.

32. A kit according to claim 31, wherein one or more projections extend from the inner wall of the collar and, in use, the projections locate in slots in the outer surface of the wall of the fitting and this prevents the collar rotating relative to the drain fitting.

33. A kit according to claim 31, wherein one or more slots are provided in the inner wall of the collar and one or more projections are provided in the outer wall of the fitting and, in use, the projections locate in the slots and prevent the collar rotating relative to the drain fitting

34. A kit according to claim 26, further comprising a nut having threads which are complementary with the threaded outer surface of the drain fitting.
